(19) United States
(12) Patent Application Publication
(10) Pub. No.: US 2005/0106929 A1
(43) Pub. Date: May 19, 2005

(54) Cable-terminating modular plug

(75) Inventors: Ted R. Meckley, Seven Valleys, PA (US); Robert G. Colantuono, Dover, PA (US); Richard D. Marowsky, York, PA (US)

Correspondence Address: STEINBERG & RASKIN, P.C., 1140 AVENUE OF THE AMERICAS, 15th FLOOR, NEW YORK, NY, 10036-5803, US

(73) Assignee: Bel Fuse, Ltd.

(21) Appl. No.: 10/714,737

(22) Filed: Nov. 17, 2003

(51) Int. Cl. H01R 4/24

(52) U.S. Cl. 439/418

(57) ABSTRACT

Modular plug for terminating a cable having twisted signal pairs of wires including a plug housing having contact blade-receiving slots at a front end and defining a longitudinally extending cavity opening at a rear end and a strain relief member defining a channel for receiving the cable. A wire aligner is interposed between the strain relief member and the housing and arranged at least partially in the cavity. The wire aligner aligns the wires of the cable into specific position relative to the slots and crimps the cable when received in the channel of the strain relief member. To crimp the cable, the wire aligner is formed with retention fingers which exert an inwardly directed force against the cable when receive din the channel of the strain relief member.

### FIELD OF THE INVENTION

The present invention relates generally to the field of modular plugs for terminating cables and more particularly, to a modular plug of the Category 6 type for terminating communication cables.

The present invention also relates to a combined wire aligner and strain relief member for cable-terminating modular plugs and modular plugs including the same.

### BACKGROUND OF THE INVENTION

Communication networks generally transmit data at a high frequency over cables having a plurality of twisted signal pairs of wires. For example, according to currently accepted performance standards, Category 5 (“Cat 5”) products operate at frequencies up to 100 MHz and Category 6 (“Cat 6”) products operate at frequencies up to 250 MHz over Unshielded Twisted Pair (UTP) cables that contain eight individual wires arranged as four twisted signal pairs. When data is transmitted via alternating current in a typical telecommunication application at such high frequencies, each individual wire and each signal pair creates an electromagnetic field that can interfere with signals on adjacent wires and adjacent signal pairs. This undesirable coupling of electromagnetic energy between adjacent wire pairs is commonly referred to as crosstalk and causes communication problems in networks.

Crosstalk is at least partially controlled within communication cables through the use of twisted pairs of wires. Twisting a signal pair of wires causes the electromagnetic fields around the wires to cancel out, leaving virtually no external field to transmit signals to nearby cable pairs.

However, a form of crosstalk referred to as Near End Crosstalk (NEXT) still occurs when modular connectors, such as modular plugs, are attached to twisted signal pairs of wires. Since twisted signal pairs must be untwisted into individual wires in order to attach a modular plug, high levels of NEXT are introduced when portions of transmitted signals within the modular plug are electromagnetically coupled back into received signals.

Modular plugs have therefore been developed for terminating communication cables that contain twisted signal pairs of wires while controlling NEXT. Controlling NEXT involves not only a reduction in NEXT but also a reduction in variations in NEXT between signal pairs of the wires because technical specifications limit acceptable variations in NEXT. In modular plugs, this is often accomplished by arranging a load bar or wire aligner in the plug housing to guide and position the wires in specific positions relative to one another, e.g., in different planes, in a path from the cable to the contact blades at a front of the plug housing.

However, it remains a problem to provide strain relief for the cable while avoiding causing NEXT and variations in NEXT between twisted signal pairs because the strain relief usually causes pinching and deformation of the cable within the plug housing which results in distortion and displacement of the twisted signal pairs of wires.

One modular cable termination plug which purports to overcome this problem with strain relief of a cable is described in U.S. Pat. No. 6,250,949 (Lin, assigned at issuance to Lucent Technologies, Inc.). In the Lin plug, the strain relief is applied outside of the plug housing. A wire aligner defines four channels, each receiving one twisted signal pair of wires, and projects rearwardly from a cavity in the plug housing. A cable crimping ring or ferrule is slipped over the wire aligner. The crimping ring holds the cable tightly against the distal edges of the wire aligner thereby ensuring strain relief by its resistance to longitudinal or axial forces. The crimping of the cable provided by the crimping ring is said to be effective to prevent the wires from being subject to lateral forces that tend to distort their orientation with respect to each other so that as a result, unpredictable changes or increases in crosstalk between the wires is avoided.

### OBJECTS AND SUMMARY OF THE INVENTION

It is an object of the present invention to provide new and improved modular plugs for terminating cables, in particular of the Cat 6 type, which provide for control of NEXT.

It is another object of the present invention to provide a combined wire aligner and strain relief member for cable-terminating modular plugs, in particular of the Cat 6 type, and modular plugs including the same.

In order to achieve these objects and others, a modular plug for terminating a cable having twisted signal pairs of wires includes a plug housing having contact blade-receiving slots at a front end and defining a longitudinally extending cavity opening at a rear end, a strain relief member defining a channel for receiving the cable, and a wire aligner interposed between the strain relief member and the housing and arranged at least partially in the cavity. The wire aligner has a dual function in the invention in that it both aligns the wires of the cable into specific positions relative to the slots in the plug housing and also crimps or pinches the cable in the channel of the strain relief member. Since the cable is not pinched in the plug housing, and distortion and displacement of the twisted signal pairs of wires of the cable within the plug housing does not occur. Accordingly, variations in NEXT are reduced.

Another advantage obtained by the use of a wire aligner which provides both wire-alignment and cable-crimping functions is that it eliminates the need for a separate cable crimping member as in some prior art constructions, e.g., the crimping ring in the '949 patent described above.

In one embodiment, the crimping function of the wire aligner is provided by integral retention fingers which extend rearwardly from the wire aligner into the channel and are inclined inward toward a center of the channel. The inclined retention fingers abut and are deformed by a tapering, conical surface of the channel to thereby exert a compressive force against the cable when received in the channel. To enhance the crimping provided by the retention fingers, serrations may be formed on an inner surface at a rearward end of the retention fingers so that the retention fingers frictionally engage the cable. This prevents relative movement between the cable and the wire aligner. Since the wire aligner is attached to the strain relief member and the plug housing, relative movement between the cable and the plug is prevented.

The wire aligner described above, which also functions as a cable crimping member, may be used with different constructions of plug housings and strain relief members. In one embodiment, the combined cable crimping member and wire aligner includes a row of wire-receiving channels formed at a front end, each receiving a respective wire of the cable, a crimping structure arranged at a rear end for crimping the cable when received in the channel of the strain relief member, e.g., a number of retention fingers such as three, and a guiding structure for guiding the wires to the channels in order to position the wires in the channels and thus in specific positions relative to the slots in the plug housing.

The guiding structure includes a vertical support wall having a forward facing surface and a rearward facing surface from which the retention fingers project rearwardly, and a second horizontal support wall. The first support wall includes an opening above the second support wall for receiving one twisted signal pair of wires and a second opening below the second support wall for receiving other pairs of wires. In this embodiment, when three retention fingers are provided, two are arranged above the second support wall alongside the first opening and one retention finger is arranged below the second opening. Vertical partition walls are also provided to separate the wires passing through the second opening.

The above construction of the guiding structure of the wire aligner is one specific manner in which twisted signal pairs of a cable can be guided from the strain relief member to the row of channels at the front end of the wire aligner. Other guiding structures can also be provided, including those which individually guide untwisted wires or guide pairs of untwisted or twisted wires.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 is an exploded perspective view of a first embodiment of a modular cable termination plug in accordance with the invention taken from the front.

FIG. 2 is an exploded perspective view of the modular cable termination plug shown in FIG. 1 taken from the rear.

FIG. 3 is a front perspective view of a modular cable termination plug shown in FIG. 1 shown terminating a cable.

FIG. 4 is a cross-sectional view taken along the line 4-4 of FIG. 3

FIG. 5 is a cross-sectional view taken along the line 5-5 of FIG. 3

FIG. 6 is a cross-sectional view taken along the line 6-6 of FIG. 3 with the wires of the cable omitted.

FIG. 7 is an exploded perspective view of a second embodiment of a modular cable termination plug in accordance with the invention taken from the rear.

### DETAILED DESCRIPTION OF THE INVENTION

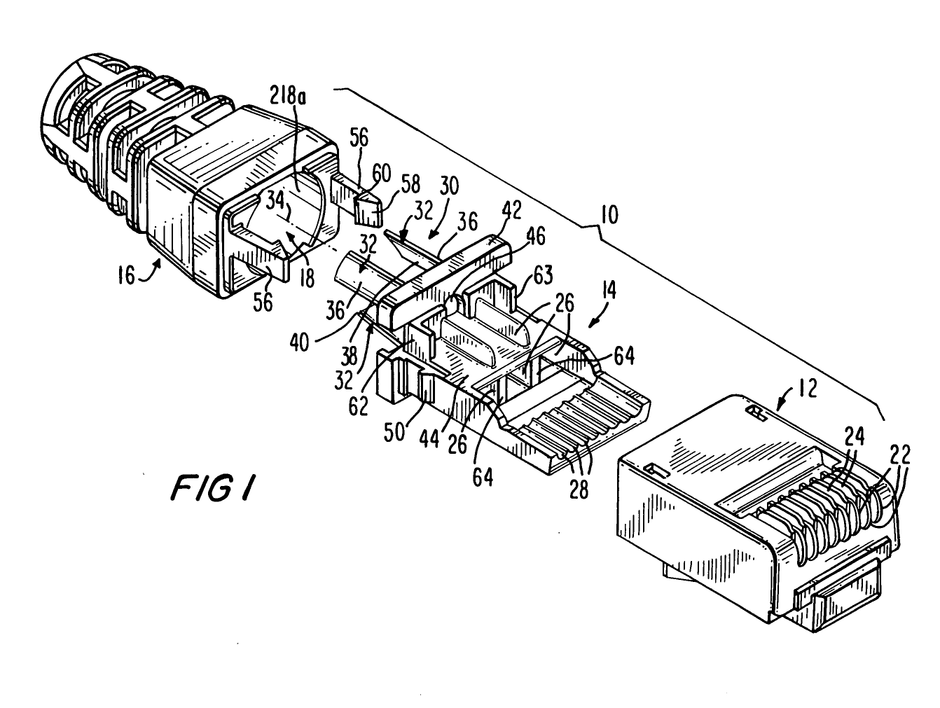

Referring to the accompanying drawings wherein like reference numerals refer to the same or similar elements, FIG. 1 shows a first embodiment of a modular plug in accordance with the invention designated generally as 10. The plug 10 is designed as a Cat 6 plug, i.e., meets the specific communications industry requirements for a modular plug capable of operating at frequencies up to 250 MHz. The plug 10 includes a housing 12 constructed for insertion into a mating connector such as a jack, a wire aligner 14 for aligning wires of a cable 8 terminated by the plug 10 and a strain relief member 16 defining a channel 18 through which the cable 8 passes.

Housing 12 includes a longitudinally extending cavity 20 opening at a rear of the housing 12. A front end of the wire aligner 14 is arranged in the cavity 20. A plurality of slots 22 are arranged at a front end of the housing 12 and each receives a contact blade 24. Housing 12 also includes other features typical of modular plugs, and in particular Cat 6 plugs, such as a latch 26.

Wire aligner 14 is interposed between the housing 12 and the strain relief member 16 and is constructed to guide the wires of the cable 8 into specific positions in the housing 12 relative to the slots 22 so that the contact blades 24 can electrically engage the wires of the cable 8 when inserted into the slots 22. To this end, the wire aligner 14 includes conduits 26 leading from a rear of the wire aligner 14 through a central portion of the wire aligner 14 and a plurality of channels 28 at a forward end. Conduits 26 each provide a specific path for one or more of the wires of the cable 8. For example, as shown in FIG. 5, each conduit 26 provides a path for a twisted pair of wires.

When the wire aligner 14 is inserted into the cavity 20 in the housing 12, the channels 28 are positioned below the slots 22, one channel 28 below each slot 22. Accordingly, when terminating a cable 8 with the plug 10, the wires of the cable 8 would be positioned in each channel 28 so that the contact blades 24 in the slots 22 can be pressed into a respective one of the wires to engage the metal core thereof and thereby provide electrical connection between the contact blades 24 and the wires of the cable 8.

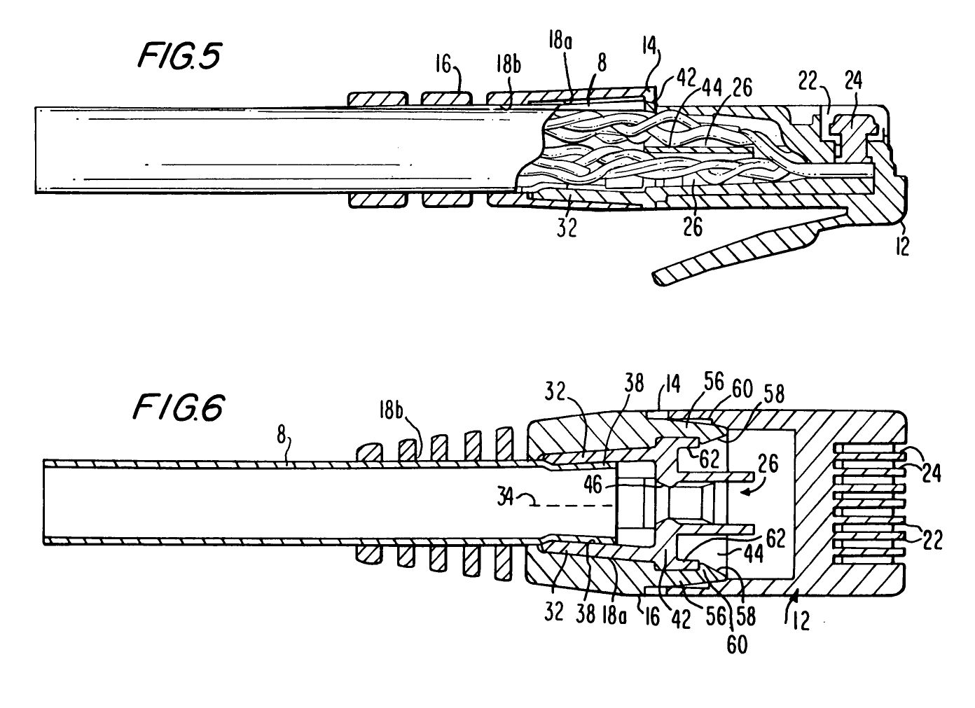

To provide strain relief for the cable 8, the wire aligner 14 includes an integral retention mechanism 30, namely, three rearwardly extending cable retention fingers 32 which will be situated in the channel 18 of the strain relief member 16 when the wire aligner 14 and strain relief member 16 are coupled to one another (see FIG. 6). The retention fingers 32 are angled toward a central axis 34 which corresponds to the central axis of the channel 18 in the strain relief member 16. If desired, the retention fingers 32 maybe spaced approximately equiangularly around the center of the channel 18.

Each cable retention finger 32 has a curved outer surface 36 and a curved inner surface 38 having ridges or serrations 40 at a rear end. The serrations 40 are provided to frictionally engage the jacket of the cable 8 in order to reduce or eliminate movement of the cable 8 relative to the retention fingers 32 and thus relative to the wire aligner 14.

The channel 18 of the strain relief member 16 has a front edge adjacent the wire aligner 14 and tapers inwardly from the front edge to an intermediate location to provide the channel 18 with a front conical portion 18a and a rear cylindrical portion 18b.

The retention fingers 32 are constructed such that when the wire aligner 14 is attached to the strain relief member 16, the retention fingers 32 are situated in the conical portion 18a of the channel 18 and are deformed inward by the conical surface of the channel 18. The inward deformation of the retention fingers 32 causes the retention fingers 32 to contact the cable 8 and press the cable 8 inward, i.e., crimp the cable 8 (See FIGS. 4 and 6). Appropriate materials from which to construct the retention fingers 32 to enable the retention fingers 32 to deform without breaking are known or readily ascertainable to those skilled in the art.

In this manner, the cable 8 is crimped by the retention fingers 32 outside of the plug housing 12 and while the wires are in twisted signal pairs, i.e., prior to the untwisting of the wires which occurs subsequently in the wire aligner 14. NEXT and variations in NEXT between twisted signal pairs are therefore avoided. A strain relief component which crimps or pinches the untwisted pairs of wires is not required.

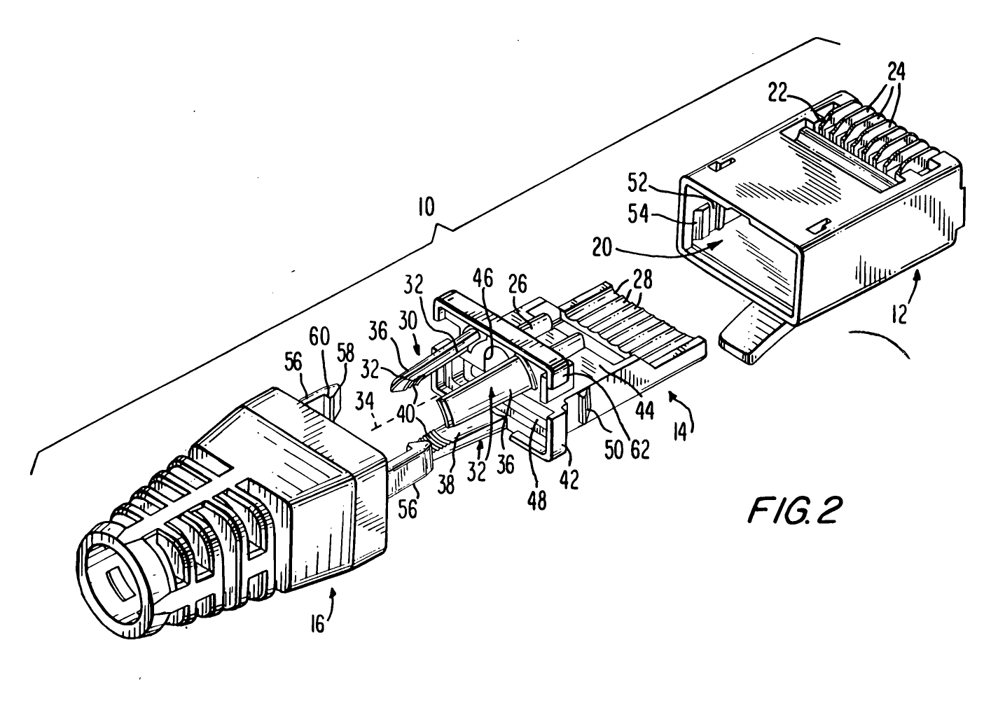

The determination of the number, location and path of the conduits 26 of the wire aligner 14, the determination of which wires are arranged in which conduit 26 and the determination of which wires are arranged in which channels 28 of the wire aligner 14 may be made based on operational considerations, such as providing for minimal crosstalk and minimal variations in crosstalk between twisted wire pairs. As shown, the wire aligner 14 includes a vertical support wall 42 having a forward facing surface and a rearward facing surface and a horizontal support wall 44 for separating the wires of the cable 8. The vertical support wall 42 includes a first opening 46 above the horizontal support wall 44 for receiving one twisted wire pair and a second opening 48 below the horizontal support wall 44 for receiving three twisted wire pairs. One conduit 26 leads from the opening 46 whereas three conduits 26 lead from the opening 48 and are separated by partition walls 64 (see FIG. 1). With this construction, one retention finger 32 is arranged above the horizontal support wall 42 on each side of the first opening 46 and another retention finger 32 is arranged below the second opening 48 (see FIG. 2).

A coupling mechanism is provided to attach the housing 12 and the wire aligner 14 together. The coupling mechanism comprises a latch 50 formed on each lateral side surface of the wire aligner 14 and a cooperating receptacle or slot 52 formed on each inner lateral wall of the housing 12 defining the cavity 20 (see FIG. 2). An angled ledge 54 is arranged rearward of each receptacle 52 to allow the latch 50 on the wire aligner 14 to slide thereover into the receptacle 52. Other structures for attaching the wire aligner 14 to the housing 12 may be applied in the invention, including those currently known to persons skilled in the modular connector art.

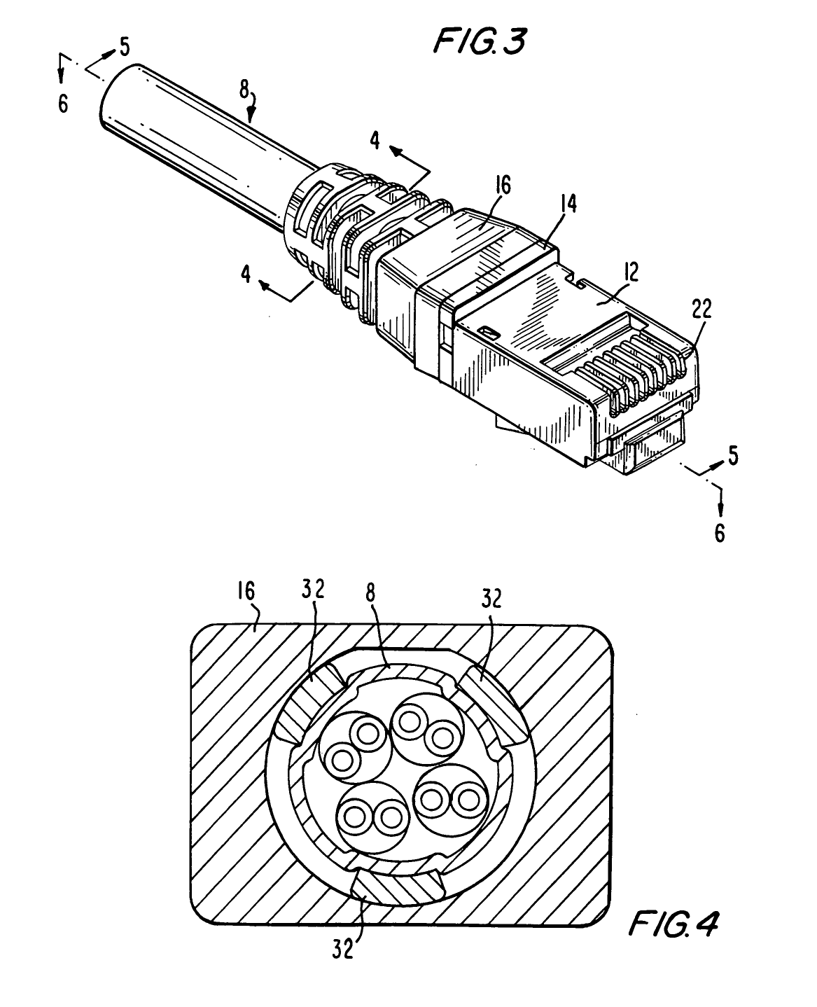

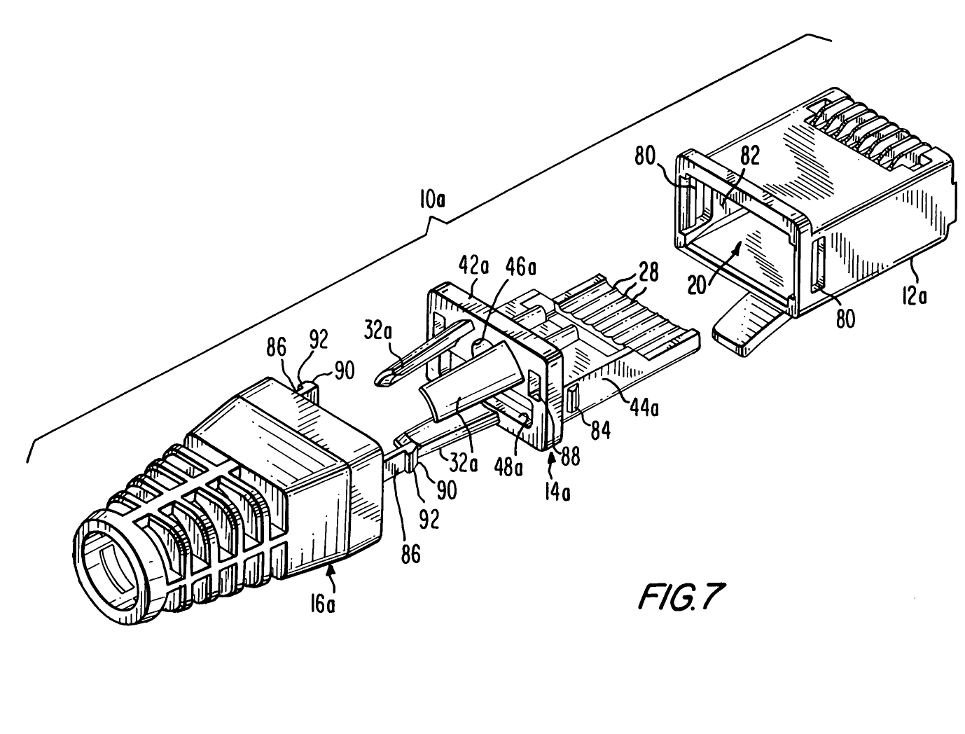

For example, as shown in FIG. 7 in which the same or similar elements to the modular plug 10 shown in FIGS. 1-6 are designated by the same reference numeral following by the letter “a”, apertures 80 are formed in the lateral walls 82 of the housing 12a and a latch or ledge 84 is formed on each lateral side surface of the wire aligner 14a which would enter into the apertures 80 of the housing 12a when the wire aligner 14a is engaged with the housing 12a. The portion of the lateral walls 82 of the housing 12a rearward of the apertures 80 is provided with an angled surfaced to enable the ledges 84 to slide thereover into the apertures 80.

A coupling mechanism is also provided to attach the wire aligner 14 and the strain relief member 16 together. The coupling mechanism comprises latches 56 formed on a forward facing surface of the strain relief member 16, one on each side of the channel 18, and longitudinally extending retention walls 62 formed on the wire aligner 14. The latches 56 have an angled front surface 58 and an inwardly facing hook section 60 so that the latches 56 are deformed outwardly when the wire aligner 14 and the strain relief member 16 are brought into engagement with one another and then snap around the retention walls 62. Once the latches 56 are engaged with the retention walls 62, the wire aligner 14 and strain relief member 16 are attached to one another and any pulling force applied to the strain relief member 16 will not cause separation of the strain relief member 16 from the wire aligner 14.

Also, any pulling force applied to the cable 8 will be transmitted to the wire aligner 14 via the crimping being applied by the retention fingers of the wire aligner 14. In view of the coupling of the wire aligner 14 to both the plug housing 12 and the strain relief member 16, the entire plug 10 will be subject to the same pulling force and there will not be any significant relative movement between the housing 12, the wire aligner 14 and the strain relief member 16.

Other structures for attaching the wire aligner 14 to the strain relief member 16 may be applied in the invention, including those currently known to persons skilled in the modular connector art. For example, as shown in FIG. 7, latches 86 may be formed on a forward facing surface of the strain relief member 16a, one on each side of the channel 18, a and apertures 88 formed on the vertical support wall 42a of the wire aligner 14a. The latches 86 have an angled front surface 90 and an outwardly facing hook section 92 so that the latches 86 are deformed inwardly when the wire aligner 14a and the strain relief member 16a are brought into engagement with one another and then snap around a rear surface of the vertical support wall 42a.

One manner to terminate a cable 8 having four twisted pairs of wires with a plug 10 in accordance with the invention will now be described. Initially, the cable 8 is passed through the channel 18 in the strain relief member 16 and a portion of the jacket of the cable 8 is removed to exposed the twisted pairs of wires. One twisted pair of wires is passed through opening 46 in the vertical support wall 42 of the wire aligner 14 into the conduit 26 above the horizontal support wall 44 and the other three twisted pairs of wires are passed through opening 48 in the vertical support wall 42, each into a respective conduit 26 separated by the partition walls 64. The wires are pulled forward of the wire aligner 14 to ensure that the wires have sufficient length to reach the front edge of the wire aligner 14.

The wire aligner 14 is then attached to the strain relief member 16 by aligning the retention fingers 32 with the channel 18 in the strain relief member 16 and pressing the wire aligner 14 and the strain relief member 16 together. As the wire aligner 14 is urged toward the strain relief member 16, the retention fingers 32 slide along the surface of the conical portion 18a of the channel 18, being slightly deformed in the process, until the retention fingers 32 engage the cable 8 at which time, continue urging of the wire aligner 14 causes the retention fingers 32 to pinch and deform the cable 8 (see FIG. 4). At the same time, the angled front surface 60 of the latches 56 contacts the side of the retention walls 62 so that the latches 56 are deformed outwardly. When the latches 56 snap around the retention walls 62, attachment of the wire aligner 14 to the strain relief member 16 is complete.

Thereafter, an untwisted portion of each wire is placed into the channels 28 in a predetermined order and excess wire beyond the front edge of the wire aligner 14 is preferably removed. The front end of the wire aligner 14 is then placed into the cavity 20 in the housing 12. When the latches 50 on the wire aligner 14 slide into the receptacles 52 in the housing 12, attachment of the wire aligner 14 to the housing 12 is complete, with the channels 28 being positioned in alignment with and below the slots 22 at this time.

The contact blades 24, which are pre-positioned in the slots 22 in the housing 12, are then pressed downward to pierce the insulation of that portion of the wires in the channels 28 in the wire aligner 14 and contact the metal core thereof. Termination of a cable 8 is thus complete.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A modular plug for terminating a cable having twisted signal pairs of wires held therein, comprising:
a plug housing having a plurality of contact blade-receiving slots at a front end and defining a longitudinally extending cavity opening at a rear end;
a strain relief member defining a channel for receiving the cable; and
a wire aligner interposed between said housing and said strain relief member and arranged at least partially in said cavity in said housing, said wire aligner aligning wires of the cable into specific position relative to said slots and including crimping means for crimping the cable when received in said channel of said strain relief member.

2. The modular plug of claim 1, wherein said crimping means comprise a plurality of retention fingers extending rearwardly from said wire aligner into said channel.

3. The modular plug of claim 2, wherein said retention fingers include serrations formed on an inner surface at a rearward end for frictionally engaging the cable.

4. The modular plug of claim 2, wherein said retention fingers are angled toward a center of said channel.

5. The modular plug of claim 2, wherein said channel has a front end adjacent said wire aligner and tapers inward from said front end, said retention fingers being deformed into contact with the cable by the tapering of said channel.

6. The modular plug of claim 2, wherein said retention fingers are spaced around a center of said channel.

7. The modular plug of claim 2, wherein said wire aligner includes a support wall having a forward facing surface and a rearward facing surface, said retention fingers being arranged to project rearwardly from said rearward facing surface of said wire aligner.

8. The modular plug of claim 2, wherein said plurality of retention fingers comprise three retention fingers.

9. The modular plug of claim 8, wherein said wire aligner includes a first support wall having a forward facing surface and a rearward facing surface and a second support wall arranged substantially perpendicular to said first support wall for separating the wires of the cable, said first support wall including a first opening above said second support wall for receiving at least one of said pairs of wires and a second opening below said second support wall for receiving at least one of said pairs of wires, two of said retention fingers being arranged above said second support wall alongside said first opening and one of said retention fingers being arranged below said second opening.

10. The modular plug of claim 1, wherein said crimping means are integral with said wire aligner.

11. The modular plug of claim 1, wherein said wire aligner includes a support wall having a forward facing surface and a rearward facing surface, said crimping means being arranged on said rearward facing surface of said support wall.

12. The modular plug of claim 1, further comprising coupling means for coupling said strain relief member to said wire aligner.

13. The modular plug of claim 12, wherein said coupling means comprise retention walls formed on said wire aligner and latches arranged on said strain relief member and engaging with and projecting forwardly over said retention walls.

14. The modular plug of claim 1, further comprising coupling means for coupling said wire aligner to said housing.

15. The modular plug of claim 14, wherein said coupling means comprise latches arranged on lateral surfaces of said wire aligner and receptacles arranged on said housing.

16. A combined cable crimping member and wire aligner for a modular plug including a housing with contact blade-receiving slots at a front end and a longitudinally extending cavity opening at a rear end, and a strain relief member defining a channel for receiving a cable having twisted signal pairs of wires, comprising:
a row of wire-receiving channels formed at a front end and adapted to be positioned in alignment with the slots in the housing, each of said channels receiving a respective wire of the cable,
crimping means arranged at a rear end for crimping the cable when received in the channel of the strain relief member, and
a guiding structure for guiding the wires to said channels.

17. The combined cable crimping member and wire aligner of claim 16, wherein said guiding structure comprises a first vertical support wall having a forward facing surface and a rearward facing surface, said crimping means being arranged on said rearward facing surface.

18. The combined cable crimping member and wire aligner of claim 17, wherein said crimping means comprise a plurality of retention fingers.

19. The combined cable crimping member and wire aligner of claim 18, wherein said retention fingers include serrations formed on an inner surface at a rearward end for frictionally engaging the cable.

20. The combined cable crimping member and wire aligner of claim 18, wherein said retention fingers are angled inward toward one another.

21. The combined cable crimping member and wire aligner of claim 18, wherein said plurality of retention fingers comprise three retention fingers.

22. The combined cable crimping member and wire aligner of claim 21, wherein said guiding structure further comprises a second horizontal support wall, said first support wall including a first opening above said second support wall for receiving at least one of the pairs of wires and a second opening below said second support wall for receiving at least one of the pairs of wires, two of said retention fingers being arranged above said second support wall alongside said first opening and one of said retention fingers being arranged below said second opening.
